(19) United States
(12) Patent Application Publication
(10) Pub. No.: US 2026/0034722 A1
(43) Pub. Date: Feb. 5, 2026

(54) THREE-DIMENSIONAL PRINTING

(71) Applicant: PERIDOT PRINT LLC, Palo Alto, CA (US)

(72) Inventors: James W. Stasiak, Corvallis, OR (US); Garry D. Hinch, Corvallis, OR (US); Robert C. Ionescu, Palo Alto, CA (US); Tyler Sims, Corvallis, OR (US)

(21) Appl. No.: 19/295,383

(22) Filed: Aug. 8, 2025

Related U.S. Application Data
(63) Continuation of application No. 17/614,594.

(51) Int. Cl. B29C 64/165; B29K 27/12; B29K 105/16; B33Y 10/00; B33Y 70/10

(52) U.S. Cl. CPC B29C 64/165; B33Y 70/10; B29K 2027/12; B29K 2105/162; B29K 2995/0006; B29K 2995/0091; B33Y 10/00

(57) ABSTRACT

A three-dimensional printing kit includes a build material composition and a dielectric agent. The build material composition includes a fluorinated polymeric material having an effective relative permittivity (εᵣ) value ranging from >3 to ≤10,000. The dielectric agent includes a dielectric material having an effective relative permittivity (εᵣ) value ranging from ≥1.1 to about ≤10,000.

### CROSS REFERENCE TO RELATED APPLICATIONS

This application is a continuation of U.S. application Ser. No. 17/614,594, filed Nov. 29, 2021, which itself is a 371 National Stage Entry of International Application No. PCT/US2019/053571, filed Sep. 27, 2019, each of which is incorporated herein by reference in its entirety.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for 3D printing disclosed herein;

FIG. 2 is a schematic flow diagram depicting an example of a 3D printing method;

FIG. 3 is a schematic flow diagram depicting another example of a 3D printing method; and

FIG. 4 is a graph depicting the dielectric constant (i.e., effective relative permittivity (εᵣ) value, Y axis) at a particular frequency (Hz, X-axis) for several example nanocomposite films and two control films.

### DETAILED DESCRIPTION

A build material composition and an inkjettable dielectric agent are disclosed herein that can be used together in a 3D printing process to form electrolytic capacitors with high energy density characteristics, or supercapacitors. These supercapacitors may have an energy density ranging from about 20 (Watt hour)/kilogram to about 100 (Watt hour)/kilogram, a power density ranging from about 50 Watts/kilogram to about 200 Watts/kilogram, a charge/discharge efficiency ranging from about 0.5% to about 0.9%, a discharge time ranging from about 1 hour to about 5 hours, and a charging time ranging from about 0.3 hours and about 3 hours.

The build material composition includes an electroactive, fluorinated polymeric material and the dielectric agent includes a dielectric material. The electroactive, fluorinated polymeric material has been found to be compatible with the thermal processing variations that take place during the 3D printing process (which utilizes a fusing agent). As such, the electroactive, fluorinated polymeric material can effectively coalesce when melted and recrystallized.

The inkjettable dielectric agent includes a dielectric material. The ability to jet the dielectric agent via any suitable inkjet printing technique enables controlled (and potentially varying) dielectric properties to be achieved at the voxel level. As such, dielectric components can be spatially incorporated into or onto 3D printed objects at the voxel level.

Furthermore, it has been found that the desirable high energy density characteristics for electrolytic capacitor applications can be obtained with the material combination without having to deposit large volume fractions of the dielectric material.

Throughout this disclosure, a weight percentage that is referred to as “wt % active” refers to the loading of an active component of a dispersion or other formulation that is present, e.g., in the dielectric, and/or build material composition. For example, a dielectric material, such as barium titanate nanoparticles, may be present in a water-based formulation (e.g., a stock solution or dispersion) before being incorporated into the dielectric agent. In this example, the wt % actives of the barium titanate nanoparticles accounts for the loading (as a weight percent) of the barium titanate nanoparticle solids that are present in the dielectric agent, and does not account for the weight of the other components (e.g., water, etc.) that are present in the stock solution or dispersion with the barium titanate nanoparticles. The term “wt %,” without the term actives, refers to either i) the loading of a 100% active component that does not include other non-active components therein, or ii) the loading of a material or component that is used “as is” and thus the wt % accounts for both active and non-active components.

### Multi-Fluid Kits, 3D Printing Kits and 3D Printing Compositions

The examples disclosed herein include multi-fluid kits, three-dimensional (3D) printing kits, and three-dimensional (3D) printing compositions.

An example of a multi-fluid kit includes a dielectric agent including a dielectric material having an effective relative permittivity (εᵣ) value ranging from ≥1.1 to about ≤10,000; a fusing agent including an energy absorber; and a detailing agent.

An example of a 3D printing kit includes a build material composition including a fluorinated polymeric material having an effective relative permittivity (εᵣ) value ranging from >3 to ≤10,000; and a dielectric agent including a dielectric material having an effective relative permittivity (εᵣ) value ranging from ≥1.1 to about ≤10,000. Some examples of the 3D printing kit further include a fusing agent including an energy absorber. In other examples, the dielectric agent includes an energy absorber and thus a separate fusing agent is not included in the 3D printing kit. Other examples of the 3D printing kit further include a detailing agent.

It is to be understood that the components of the multi-fluid kits and/or the 3D printing kits may be maintained separately until used together in examples of the 3D printing method disclosed herein.

As used herein, it is to be understood that the terms “material set” or “kit” may, in some instances, be synonymous with “composition.” Further, “material set” and “kit” are understood to be compositions comprising one or more components where the different components in the compositions are each contained in one or more containers, separately or in any combination, prior to and during printing but these components can be combined together during printing. The containers can be any type of a vessel, box, or receptacle made of any material.

As mentioned above, various agents may be included in the 3D printing kits disclosed herein. Examples of the build material composition and compositions of the dielectric agent, the fusing agent, the detailing agent, and the coloring agent, will now be described.

### Build Material Composition

The build material composition includes a fluorinated polymeric material having an effective relative permittivity (εᵣ) value (i.e., the ratio to absolute permittivity, 1.0) ranging from >3 to ≤10,000.

The fluorinated polymeric material may be any crystalline or semi-crystalline fluorinated polymeric material that i) has an effective relative permittivity (εᵣ) value ranging from >3 to ≤10,000, ii) has electroactive properties, and iii) has a wide processing window of greater than 5° C. (i.e., the temperature range between the melting point and the re-crystallization temperature).

In an example, the fluorinated polymeric material may have a melting point ranging from about 100° C. to about 200° C., and a recrystallization temperature that is from about 10° to about 40° less than the melting point. In other examples, the polymer may have a melting point ranging from about 110° C. to about 170° C., and a recrystallization temperature ranging from about 80° C. to about 140° C. In still other examples, the polymer may have a melting point ranging from about 152° C. to about 170° C., and a recrystallization temperature ranging from about 130° C. to about 140° C.

The fluorinated polymeric material may be polyvinylidene fluoride (PVDF), a polyvinylidene fluoride copolymer, a polyvinylidene fluoride terpolymer, or blends thereof. Examples of suitable PVDF copolymers include a poly(vinylidene fluoride-trifluoroethylene) copolymer, a poly(vinylidene fluoride-tetrafluoroethylene) copolymer, a poly(vinylidene fluoride-hexafluoropropylene) copolymer, a poly(vinylidene fluoride-chlorofluoroethylene) copolymer, a poly(vinylidene fluoride-chlorotrifluoroethylene) copolymer, or the like. Examples of suitable PVDF terpolymers include a poly(vinylidene fluoride-trifluoroethylene-chlorotrifluoroethylene) terpolymer, a poly(vinylidene fluoride-trifluoroethylene-chlorofluoroethylene) terpolymer, or the like.

In an example, the fluorinated polymeric material is selected from the group consisting of polyvinylidene fluoride, a poly(vinylidene fluoride-trifluoroethylene) copolymer, a poly(vinylidene fluoride-tetrafluoroethylene) copolymer, a poly(vinylidene fluoride-hexafluoroethylene) copolymer, a poly(vinylidene fluoride-hexafluoropropylene) copolymer, a poly(vinylidene fluoride-chlorofluoroethylene) copolymer, a poly(vinylidene fluoride-chlorotrifluoroethylene) copolymer, a poly(vinylidene fluoride-trifluoroethylene-chlorotrifluoroethylene) terpolymer, a poly(vinylidene fluoride-trifluoroethylene-chlorofluoroethylene) terpolymer, and blends thereof.

In some examples, the fluorinated polymeric material may be in the form of a powder. In other examples, the fluorinated polymeric material may be in the form of a powder-like material, which includes, for example, short fibers having a length that is greater than its width. In some examples, the powder or powder-like material may be formed from, or may include, short fibers that may, for example, have been cut into short lengths from long strands or threads of material.

The fluorinated polymeric material may be made up of similarly sized particles and/or differently sized particles. In an example, the average particle size of the fluorinated polymeric material ranges from about 2 μm to about 225 μm. In another example, the average particle size of the fluorinated polymeric material ranges from about 10 μm to about 130 μm. The term “average particle size”, as used herein, may refer to a number-weighted mean diameter or a volume-weighted mean diameter of a particle distribution.

In some examples, the fluorinated polymeric material does not substantially absorb radiation having a wavelength within the range of 300 nm to 1400 nm. The phrase “does not substantially absorb” means that the absorptivity of the fluorinated polymeric material at a particular wavelength is 25% or less (e.g., 20%, 10%, 5%, etc.).

In some examples, the fluorinated polymeric material makes up 100% of the build material composition. In other examples, in addition to the fluorinated polymeric material, the build material composition may include an antioxidant, a whitener, an antistatic agent, a flow aid, a plasticizer, a compatibilizer, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the fluorinated polymeric material and/or to prevent or slow discoloration (e.g., yellowing) of the fluorinated polymeric material by preventing or slowing oxidation of the fluorinated polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the fluorinated polymeric material. In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any example of the whitener may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al₂O₃), tricalcium phosphate (E341), powdered cellulose (E460 (ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

Plasticizers and/or compatibilizers may also be added to the build material composition. Example plasticizers include ethylene carbonate, dibutyl phthalate, ionic liquids, etc. An example compatibilizer includes poly(methyl methacrylate) (PMMA). The plasticizer or compatibilizer may be added in an amount ranging from greater than 0 wt % to less than 12 wt %, based upon the total weight of the build material composition.

### Dielectric Agent

The dielectric agent includes a dielectric material having an effective relative permittivity (εᵣ) value ranging from ≥1.1 to about ≤10,000. In an example, the dielectric material has an effective εᵣ value ranging from about 1.1 to about 100. In another example, the dielectric material has an effective εᵣ value ranging from about 2 to about 80. In still another example, the dielectric material has an effective εᵣ value ranging from about 3 to about 10. In yet another example, the dielectric material has an effective εᵣ value ranging from about 1.4 to about 8. In still another example, the dielectric material has an effective εᵣ value ranging from about 2 to about 5.

In an example, the dielectric material is barium titanate (BaTiO₃) nanoparticles. Other examples of the dielectric material include lead zirconium titanate (PZT) nanoparticles, silicon dioxide (SiO₂) nanoparticles, silicon nitride (SisN₄) nanoparticles, aluminum oxide (Al₂O₃) nanoparticles, zirconium oxide (ZrO₂) nanoparticles, titanium oxide (TiO₂) nanoparticles, tantalum pentoxide (Ta₂O₅) nanoparticles, barium strontium titanate (BST) nanoparticles, and strontium titanate oxide (SrTiO₃) nanoparticles. In still another example, the dielectric material is a metal oxide. Examples of suitable metal oxides may be selected from the group consisting of barium titanate nanoparticles, lead zirconium titanate nanoparticles, silicon dioxide nanoparticles, aluminum oxide nanoparticles, zirconium oxide nanoparticles, titanium oxide nanoparticles, tantalum pentoxide nanoparticles, barium strontium titanate nanoparticles, strontium titanate oxide nanoparticles, and combinations thereof.

Examples of the dielectric material that have an effective εᵣ value ranging from about 1.1 to about 100, or ranging from about 2 to about 80, include barium titanate nanoparticles, lead zirconium titanate nanoparticles, silicon dioxide nanoparticles, silicon nitride nanoparticles, aluminum oxide nanoparticles, zirconium oxide nanoparticles, titanium oxide nanoparticles, tantalum pentoxide nanoparticles, barium strontium titanate nanoparticles, and strontium titanate oxide nanoparticles. Examples of the dielectric material that have an effective εᵣ value ranging from about 3 to about 10 include silicon dioxide nanoparticles, silicon nitride nanoparticles, and aluminum oxide nanoparticles. In some instances, the dielectric material having an effective εᵣ value ranging from about 3 to about 10 may also include zirconium oxide, titanium oxide, and tantalum pentoxide. Examples of the dielectric material that have an effective εᵣ value ranging from about 1.4 to about 8, or ranging from about 2 to about 5 include silicon dioxide nanoparticles and silicon nitride nanoparticles. In some instances, the dielectric material having an effective εᵣ value ranging from about 2 to about 5 may also include aluminum oxide.

In an example, the dielectric material has an average particle size ranging from about 10 nm to about 100 nm. In another example, the dielectric material has an average particle size ranging from about 10 nm to about 50 nm. In still another example, the dielectric material has an average particle size of about 50 nm. In yet another example, the dielectric material has an average particle size of about 100 nm. As noted herein, the average particle size may refer to a number-weighted mean diameter or a volume-weighted mean diameter of a particle distribution.

In an example, the dielectric material is present in the dielectric agent in an amount ranging from about 2 wt % to about 50 wt %, based on the total weight of the dielectric agent. In another example, the dielectric material is present in the dielectric agent in an amount ranging from about 5 wt % to about 45 wt %, based on the total weight of the dielectric agent. In still another example, the dielectric material is present in the dielectric agent in an amount of about 22 wt %, based on the total weight of the dielectric agent. It is believed that these dielectric material loadings provide a balance between the dielectric agent having jetting reliability and efficiency in enhancing the dielectric property.

In addition to the dielectric material, the dielectric agent may also include a vehicle in which the dielectric material is dispersed. A dispersant may also be included to aid in dispersing the dielectric material in the vehicle. In an example, the dispersant is included in the dielectric agent in an amount up to 5 wt % of the total weight of the dielectric agent. In an example, the dispersant is present in an about ranging from about 0.1 wt % to about 5 wt %. In an example, mass ratio of the dielectric material to the dispersant in the dielectric agent may range from about 50:0.1 (500) to about 2:5 (0.4). In an example, the mass ratio of the dielectric material to the dispersant in the dielectric agent ranges from about 60:1 to about 2:1. In another example, the mass ratio of the dielectric material to the dispersant in the dielectric agent is about 20:1.

Examples of suitable dispersants include polymer or small molecule dispersants, charged groups attached to the energy absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

In some examples, the vehicle of the dielectric agent includes water, a co-solvent, and a surfactant. In other examples, the dielectric agent may also include one or more other additives, such as an anti-kogation agent, an antimicrobial agent, and/or a chelating agent.

Water may make up the balance of the dielectric agent. As such, the amount of water may vary depending upon the amounts of the other components that are included. In some examples, the water can be present in the dielectric agent in an amount ranging from about 40 wt % to about 96 wt %. As an example, deionized water may be used.

The dielectric agent may also include a co-solvent. In an example, the total amount of the co-solvent(s) present in the dielectric agent ranges from about 5 wt % to about 45 wt %, based on the total weight of the dielectric agent. In another example, the total amount of the co-solvent(s) present in the dielectric agent is about 20 wt %.

Classes of organic co-solvents that may be used in the hydrophobic agent include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, 2-pyrrolidone, 1-methyl-2-pyrrolidone, 1-(2-hydroxyethyl)-2-pyrrolidone, 2-methyl-1,3-propanediol, and the like. Other examples of organic co-solvents include dimethyl sulfoxide (DMSO), isopropyl alcohol, ethanol, pentanol, acetone, or the like. Still other suitable co-solvents include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-5 Methoxy-3-Methyl-1-butanol, isobutyl alcohol, 1,4-butanediol, N,N-dimethyl acetamide, and combinations thereof.

The co-solvent(s) of the dielectric agent may depend, in part upon the jetting technology that is to be used to dispense the dielectric agent. For example, if thermal inkjet printheads are to be used, water and/or ethanol and/or other longer chain alcohols (e.g., pentanol) may make up 35 wt % or more of the dielectric agent. For another example, if piezoelectric inkjet printheads are to be used, 35 wt % or more of the dielectric agent may be ethanol, isopropanol, acetone, etc., and water may or may not be included.

The viscosity of the dielectric agent may be adjusted for the type of printhead that is to be used, and the viscosity may be adjusted by adjusting the co-solvent level, the dielectric material level, and/or adding a viscosity modifier. When used in a thermal inkjet printer, the viscosity of the pre-treatment composition may be modified to range from about 1 centipoise (cP) to about 9 cP (at 20° C. to 25° C.), and when used in a piezoelectric printer, the viscosity of the pre-treatment composition may be modified to range from about 2 cP to about 20 cP (at 20° C. to 25° C.), depending on the viscosity of the printhead that is being used (e.g., low viscosity printheads, medium viscosity printheads, or high viscosity printheads). Since piezoelectric inkjet printheads can deliver higher viscosity agents than thermal inkjet printheads, it may be desirable to formulate the dielectric agent for piezoelectric inkjet printing because it can include a higher concentration of the dielectric material.

The dielectric agent may include surfactant(s) to improve the jettability of the dielectric agent. In an example, the total amount of the surfactant(s) present in the dielectric agent ranges from about 0.04 wt % active to about 6 wt % active, based on the total weight of the dielectric agent. In another example, the total amount of the surfactant(s) present in the dielectric agent is about 0.4 wt % active.

Examples of suitable surfactants include a self-emulsifiable, non-ionic wetting agent based on acetylenic diol chemistry (e.g., SURFYNOL® SEF from Evonik Ind.), a non-ionic fluorosurfactant (e.g., CAPSTONE® fluorosurfactants, such as CAPSTONE® FS-35, from Chemours, previously known as ZONYL FSO), and combinations thereof. In other examples, the surfactant is an ethoxylated low-foam wetting agent (e.g., SURFYNOL® 465, SURFYNOL® 440 or SURFYNOL® CT-111 from Evonik Ind.) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company).

In some examples, the dielectric agent may include an anti-kogation agent. The total amount of anti-kogation agent(s) in the dielectric agent may range from greater than 0 wt % active to about 0.65 wt % active, based on the total weight of the dielectric agent. In an example, total amount of anti-kogation agent(s) in the dielectric agent may range greater than 0 wt % active to about 0.65 wt % active, based on the total weight of the dielectric agent. In another example, the total amount of anti-kogation agent(s) in the dielectric agent may range from greater than 0.20 wt % active to about 0.65 wt % active, based on the total weight of the dielectric agent.

The dielectric agent may include the anti-kogation agent when it is to be jetted using thermal inkjet printing. Kogation refers to the deposit of dried printing liquid (e.g., dielectric agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol).

The vehicle of the dielectric agent may also include antimicrobial agent(s). In an example, the dielectric agent may include a total amount of antimicrobial agents that ranges from about 0.0001 wt % active to about 1 wt % active. In an example, the antimicrobial agent(s) is/are a biocide(s) and is/are present in the dielectric agent in an amount ranging from about 0.25 wt % active to about 0.35 wt % active (based on the total weight of the dielectric agent).

Suitable antimicrobial agents include biocides and fungicides. Example antimicrobial agents may include the NUOSEPT™ (Troy Corp.), UCARCIDE™ (The Dow Chemical Company), ACTICIDE® B20 (Thor Chemicals), ACTICIDE® M20 (Thor Chemicals), ACTICIDER MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from The Dow Chemical Company).

Chelating agents (or sequestering agents) may be included in the vehicle of the dielectric agent to eliminate the deleterious effects of heavy metal impurities. Whether a single chelating agent is used or a combination of chelating agents is used, the total amount of chelating agent(s) in the dielectric agent may range from greater than 0 wt % active to about 2 wt % active based on the total weight of the dielectric agent. In an example, the chelating agent(s) is/are present in the dielectric agent in an amount of about 0.05 wt % active (based on the total weight of the dielectric agent).

Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

In an example, the dielectric agent has a potential hydrogen (pH) value ranging from about 7 to about 9. A pH within this range is desirable, as some examples of the dielectric material may become hydrolytically unstable at pH values outside of this range. Whether the dielectric material will become hydrolytically unstable at pH values outside of this range may depend, in part, on the dielectric material used and/or the particle size of the dielectric material (which affects its ability to stay suspended in the agent).

In some examples, the dielectric agent may also include an energy absorber (e.g., inorganic pigments). When the dielectric agent includes the energy absorber, the dielectric agent may act as both the dielectric agent and the fusing agent. This example of the dielectric agent is referred to herein as a single patterning agent. In these examples, a separate fusing agent may not be included in the 3D printing kit or utilized in the method. When the dielectric agent includes the energy absorber, it is to be understood that the energy absorber is compatible with the vehicle of the dielectric agent (i.e., is able to be incorporated into the dielectric agent).

In an example, the amount of the energy absorber ranges from 0 wt % to about 12 wt % active, based on a total weight of the dielectric agent. In another example, the amount of the energy absorber that is present in the dielectric agent ranges from greater than 0 wt % active to about 12 wt % active, based on the total weight of the dielectric agent. In other examples, the amount of the energy absorber in the dielectric agent ranges from greater than 0 wt % active to about 6 wt % active, from about 3 wt % active to 6 wt % active, or from greater than 4.0 wt % active up to about 6 wt % active. It is believed that these energy absorber loadings provide a balance between the dielectric agent having jetting reliability and energy absorbance efficiency.

The energy absorber may be any of the examples described herein with reference to the fusing agent. When both the energy absorber and the dispersant are included in the dielectric agent, the dispersant may also help to disperse the energy absorber throughout the vehicle of the dielectric agent.

If it is desirable to decouple the energy absorption from the exhibition of the dielectric property, the dielectric agent may be devoid of the energy absorber and a separate fusing agent may be used. Additionally, it may be desirable for the fusing agent to be separate and distinct from the dielectric agent when different portions of a 3D object are to exhibit different dielectric properties.

As used herein, the term “devoid of” when referring to a component (such as, e.g., the energy absorber, etc.) may refer to a composition that does not include any added amount of the component, but may contain residual amounts, such as in the form of impurities. The components may be present in trace amounts, and in one aspect, in an amount of less than 0.1 weight percent (wt %) based on the total weight of the composition (e.g., dielectric agent), even though the composition is described as being “devoid of” the component. In other words, “devoid of” a component may mean that the component is not specifically included, but may be present in trace amounts or as an impurity inherently present in certain ingredients.

### Fusing Agents

The multi-fluid kit(s) and 3D printing kit(s) disclosed herein may include a fusing agent. The fusing agent includes an energy absorber and a fusing agent vehicle.

The amount of the energy absorber that is present in the fusing agent ranges from greater than 0 wt % active to about 40 wt % active based on the total weight of the fusing agent. In other examples, the amount of the energy absorber in the fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the fusing agent having jetting reliability and heat and/or radiation absorbance efficiency.

Some of the energy absorbers have an average particle diameter (e.g., volume-weighted mean diameter) ranging from greater than 0 nm to less than 220 nm. In another example, the energy absorber has an average particle diameter ranging from greater than 0 nm to 120 nm. In a still another example, the energy absorber has an average particle diameter ranging from about 10 nm to about 200 nm

The energy absorber has substantial absorption (e.g., 80%) in the visible region (400 nm-780 nm) and/or in the infrared region (e.g., 800 nm to 4000 nm).

It is desirable for the energy absorber to be non-electrically conducting, so that it does not interfere with the dielectric properties of the 3D object. When an electrically conductive energy absorber is utilized, the volume fraction present in the dielectric portion(s) of the 3D object should be 33 vol. % or less.

Some examples of the energy absorber have absorption at wavelengths ranging from 800 nm to 4000 nm and have transparency at wavelengths ranging from 400 nm to 780 nm. As used herein “absorption” means that at least 80% of radiation having wavelengths within the specified range is absorbed. Also used herein, “transparency” means that 25% or less of radiation having wavelengths within the specified range is absorbed. This absorption and transparency allows the fusing agent to absorb enough radiation to coalesce/fuse the build material composition in contact therewith while enabling the 3D objects (or 3D objects regions) to be white or slightly colored.

The absorption of these energy absorbers is the result of plasmonic resonance effects. Electrons associated with the atoms of the energy absorber may be collectively excited by radiation, which results in collective oscillation of the electrons. The wavelengths that can excite and oscillate these electrons collectively are dependent on the number of electrons present in the energy absorber particles, which in turn is dependent on the size of the energy absorber particles. The amount of energy that can collectively oscillate the particle's electrons is low enough that very small particles (e.g., 1-100 nm) may absorb radiation with wavelengths several times (e.g., from 8 to 800 or more times) the size of the particles. The use of these particles allows the fusing agent to be inkjet jettable as well as electromagnetically selective (e.g., having absorption at wavelengths ranging from 800 nm to 4000 nm and transparency at wavelengths ranging from 400 nm to 780 nm).

In an example, this type of energy absorber is an inorganic pigment. Examples of suitable inorganic pigments include lanthanum hexaboride (LaB₆), tungsten bronzes (AxWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AxFeyPO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AxWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

One example of the fusing agent includes cesium tungsten oxide (CTO) nanoparticles as the energy absorber. The CTO nanoparticles have a formula of CsₓWO₃, where 0<x<1. The cesium tungsten oxide nanoparticles may give the fusing agent a light blue color. The strength of the color may depend, at least in part, on the amount of the CTO nanoparticles in the fusing agent. In an example, the CTO nanoparticles may be present in the fusing agent in an amount ranging from about 1 wt % to about 20 wt % (based on the total weight of the fusing agent).

The average particle size (e.g., volume-weighted mean diameter) of the CTO nanoparticles may range from about 1 nm to about 40 nm. In some examples, the average particle size of the CTO nanoparticles may range from about 1 nm to about 15 nm or from about 1 nm to about 10 nm. The upper end of the particle size range (e.g., from about 30 nm to about 40 nm) may be less desirable, as these particles may be more difficult to stabilize.

When CTO nanoparticles are used as the energy absorber, a zwitterionic stabilizer may also be included in the fusing agent. The zwitterionic stabilizer may improve the stabilization of this example of the fusing agent. While the zwitterionic stabilizer has an overall neutral charge, at least one area of the molecule has a positive charge (e.g., amino groups) and at least one other area of the molecule has a negative charge. The CTO nanoparticles may have a slight negative charge. The zwitterionic stabilizer molecules may orient around the slightly negative CTO nanoparticles with the positive area of the zwitterionic stabilizer molecules closest to the CTO nanoparticles and the negative area of the zwitterionic stabilizer molecules furthest away from the CTO nanoparticles. Then, the negative charge of the negative area of the zwitterionic stabilizer molecules may repel CTO nanoparticles from each other. The zwitterionic stabilizer molecules may form a protective layer around the CTO nanoparticles, and prevent them from coming into direct contact with each other and/or increase the distance between the particle surfaces (e.g., by a distance ranging from about 1 nm to about 2 nm). Thus, the zwitterionic stabilizer may prevent the CTO nanoparticles from agglomerating and/or settling in the fusing agent.

Examples of suitable zwitterionic stabilizers include C₂ to C₈ betaines, C₂ to C₈ aminocarboxylic acids having a solubility of at least 10 g in 100 g of water, taurine, and combinations thereof. Examples of the C₂ to C₈ aminocarboxylic acids include beta-alanine, gamma-aminobutyric acid, glycine, and combinations thereof.

The zwitterionic stabilizer may be present in the fusing agent in an amount ranging from about 2 wt % to about 35 wt % (based on the total weight of the fusing agent). When the zwitterionic stabilizer is the C₂ to C₈ betaine, the C₂ to C₈ betaine may be present in an amount ranging from about 8 wt % to about 35 wt % of the total weight of the fusing agent. When the zwitterionic stabilizer is the C₂ to C₈ aminocarboxylic acid, the C₂ to C₈ aminocarboxylic acid may be present in an amount ranging from about 2 wt % to about 20 wt % of the total weight of the fusing agent. When the zwitterionic stabilizer is taurine, taurine may be present in an amount ranging from about 2 wt % to about 35 wt % of the total weight of the fusing agent. The weight ratio of the CTO nanoparticles to the zwitterionic stabilizer may range from 1:10 to 10:1; or the weight ratio of the CTO nanoparticles to the zwitterionic stabilizer may be 1:1.

Other examples of the energy absorption have substantial absorption (e.g., 80%) at least in the visible region (400 nm-780 nm). These energy absorbers may also absorb energy in the infrared region (e.g., 800 nm to 4000 nm). This absorption generates heat suitable for coalescing/fusing the build material composition in contact therewith during 3D printing, which leads to 3D objects (or 3D objects regions) having mechanical integrity and relatively uniform mechanical properties (e.g., strength, elongation at break, etc.). This absorption, however, also results in strongly colored, e.g., black, 3D objects (or 3D objects regions).

Examples of these energy absorbers include infrared light absorbing colorants. Any near-infrared colorants, e.g., those produced by Fabricolor, Eastman Kodak, or BASF, Yamamoto, may be used in the core fusing agent. As one example, the fusing agent may be a printing liquid formulation including carbon black as the active material. Examples of this printing liquid formulation are commercially known as CM997A, 516458, C18928, C93848, C93808, or the like, all of which are available from HP Inc.

Examples of these energy absorbers also include near-infrared absorbing dyes. Examples of this printing liquid formulation are described in U.S. Pat. No. 9,133,344, incorporated herein by reference in its entirety. Some examples of the near-infrared absorbing dye are water-soluble near-infrared absorbing dyes, such as phthalocyanine dyes selected from the group consisting of:

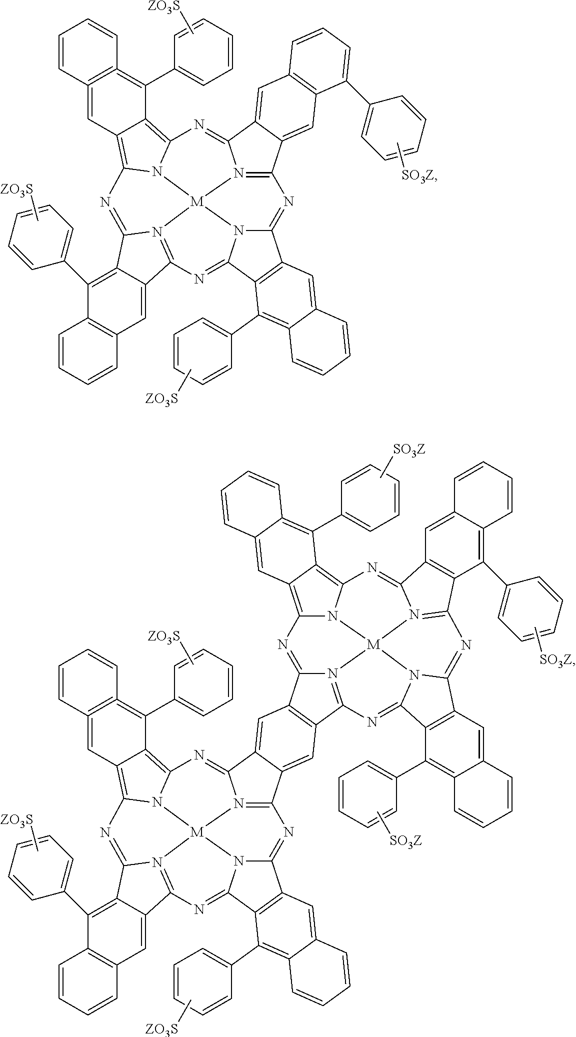

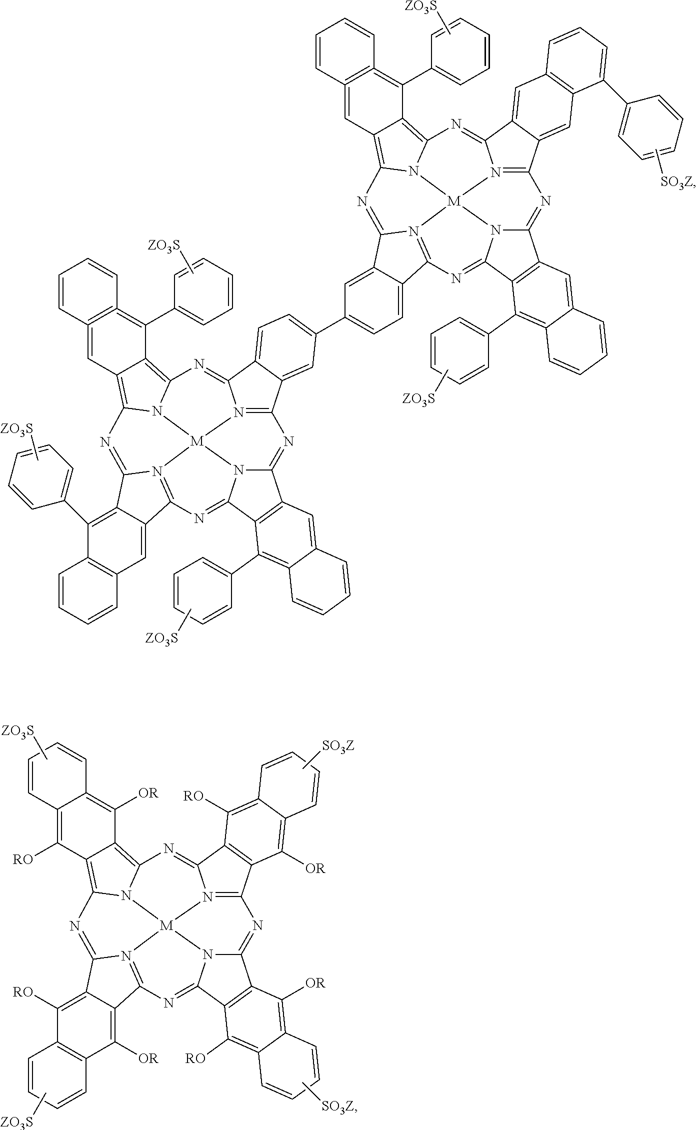

and mixtures thereof. In the above formulations, M can be a divalent metal atom (e.g., copper, etc.) or can have OSO₃Na axial groups filing any unfiled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

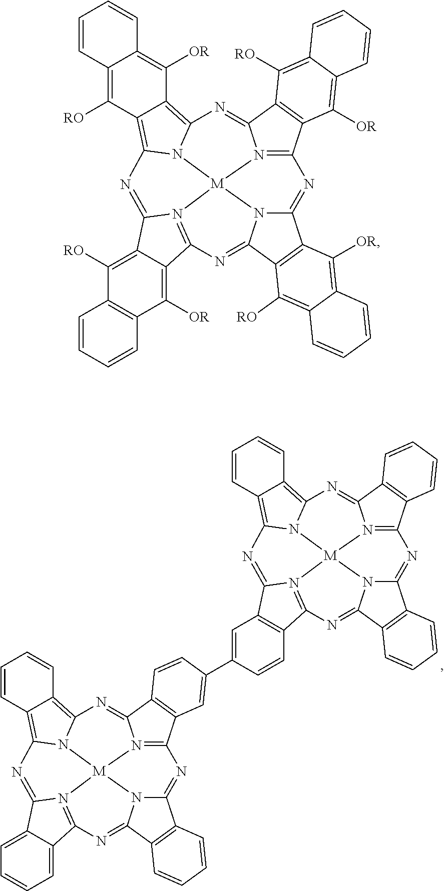

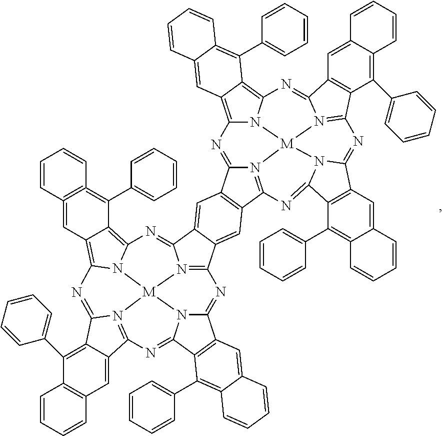

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used in the core fusing agent. Some examples include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

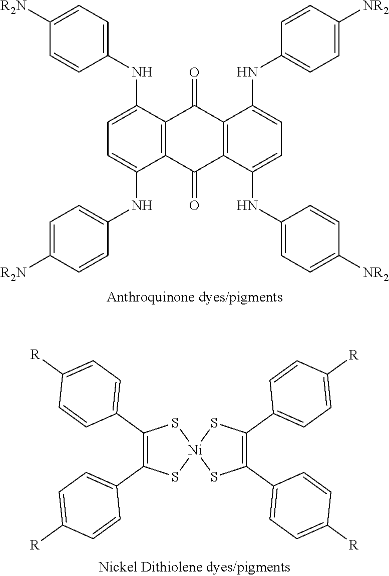

where R in the anthraquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈alkyl group (including substituted alkyl and unsubstituted alkyl), or the like.

Cyanine dyes or pigments and perylenediimide dyes or pigments may have the following structures, respectively:

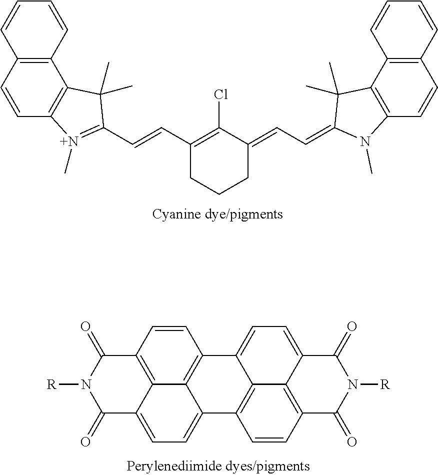

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

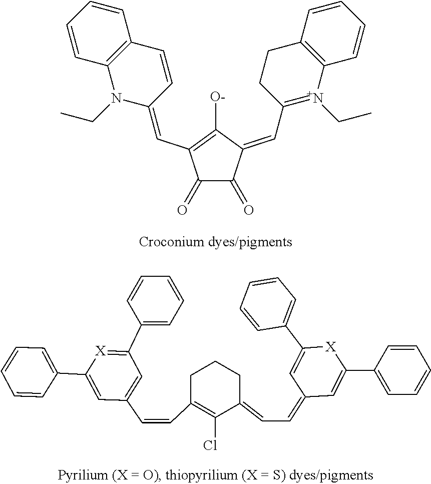

Boron-dipyrromethene dyes or pigments and aza-boron-dipyrromethene dyes or pigments may have the following structures, respectively:

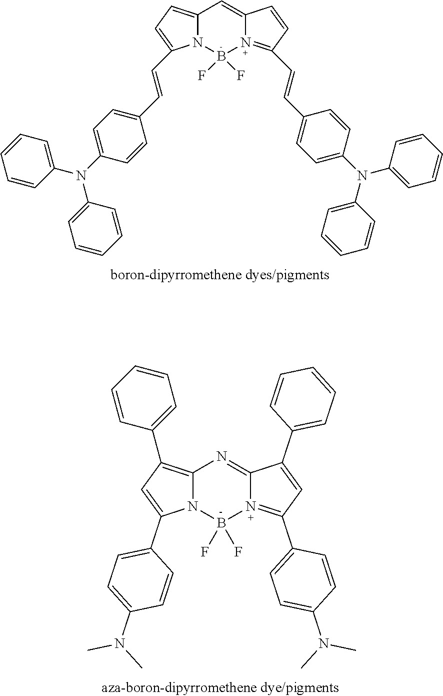

Other suitable near-infrared absorbing dyes may include ammonium dyes, tetraaryldiamine dyes, and others.

Other near infrared absorbing materials include conjugated polymers (i.e., a polymer that has a backbone with alternating double and single bonds), such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof.

Still other examples of suitable energy absorbers absorb at least some of the wavelengths within the range of 400 nm to 4000 nm. Examples include glass fibers, titanium dioxide, clay, mica, talc, barium sulfate, calcium carbonate, phosphate pigments, and/or silicate pigments.

Phosphates may have a variety of counterions, such as copper, zinc, iron, magnesium, calcium, strontium, the like, and combinations thereof. Examples of phosphates can include M2P2O7, M4P2O9, M5P2O10, M3(PO4)2, M(PO3)2, M2P4O12, and combinations thereof, where M represents a counterion having an oxidation state of +2, such as those listed above or a combination thereof. For example, M2P2O7 can include compounds such as Cu2P2O7, Cu/MgP2O7, Cu/ZnP2O7, or any other suitable combination of counterions. Silicates can have the same or similar counterions as phosphates. Example silicates can include M2SiO4, M2Si2O6, and other silicates where M is a counterion having an oxidation state of +2. For example, the silicate M2Si2O6 can include Mg2Si2O6, Mg/CaSi2O6, MgCuSi2O6, Cu2Si2O6, Cu/ZnSi2O6, or other suitable combination of counterions. It is noted that the phosphates and silicates described herein are not limited to counterions having a +2 oxidation state, and that other counterions can also be used to prepare other suitable near-infrared pigments.

Some examples of the energy absorber may be dispersed throughout the fusing agent with a dispersant. The dispersant in the fusing agent may be any of the examples described herein with reference to the dielectric agent. The dispersant helps to uniformly distribute the energy absorber throughout the fusing agent. Whether a single dispersant is used or a combination of dispersants is used, the total amount of dispersant(s) in the fusing agent may be up to about 5 wt % of the total weight of the fusing agent. In an example, the total amount of dispersant(s) in the fusing agent may ranging from about 0.1 wt % to about 5 wt %. A mass ratio of the energy absorber to the dispersant in the fusing agent may range from about 40:0.1 (400) to about 1:5 (0.2). In an example, the mass ratio of the energy absorber to the dispersant in the fusing agent ranges from about 60:1 to about 2:1. In another example, the mass ratio of the dielectric material to the dispersant in the dielectric agent is about 20:1.

Some examples of the fusing agent also include a silane coupling agent. A silane coupling agent may be added to the fusing agent to help bond an organic component (e.g., dispersant) and an inorganic component (e.g., pigment). Examples of suitable silane coupling agents include the SILQUEST® A series manufactured by Momentive.

Whether a single silane coupling agent is used or a combination of silane coupling agents is used, the total amount of silane coupling agent(s) in the fusing agent may range from about 0.1 wt % to about 50 wt % based on the weight of the energy absorber in the fusing agent. In an example, the total amount of silane coupling agent(s) in the fusing agent ranges from about 1 wt % to about 30 wt % based on the weight of the energy absorber. In another example, the total amount of silane coupling agent(s) in the fusing agent ranges from about 2.5 wt % to about 25 wt % based on the weight of the energy absorber.

As mentioned, the fusing agent also includes a liquid vehicle. The fusing agent vehicle, or “FA vehicle,” may refer to the liquid in which the energy absorber is/are dispersed or dissolved to form the fusing agent. A wide variety of FA vehicles, including aqueous and non-aqueous vehicles, may be used in the fusing agents. In some examples, the FA vehicle may include water alone or a non-aqueous solvent alone with no other components. In other examples, the FA vehicle may include other components, depending, in part, upon the applicator that is to be used to dispense the fusing agent. Examples of other suitable fusing agent components include co-solvent(s), humectant(s), surfactant(s), antimicrobial agent(s), anti-kogation agent(s), and/or chelating agent(s). It is to be understood that any of the include co-solvent(s), surfactant(s), anti-kogation agent(s), antimicrobial agent(s), and/or chelating agent(s) described herein for the dielectric agent may be used in any examples of the fusing agent in any of the amounts provided, except that the percentages will be with respect to the total weight of the fusing agent.

The fusing agent may also include a humectant. In an example, the total amount of the humectant(s) present in the fusing agent ranges from about 3 wt % active to about 10 wt % active, based on the total weight of the fusing agent.

An example of a suitable humectant is ethoxylated glycerin having the following formula:

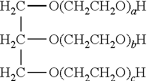

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The balance of the fusing agent(s) is water (e.g., deionized water, purified water, etc.), which as described herein, may vary depending upon the other components in the fusing agent(s).

### Detailing Agent

Some examples of the multi-fluid kit and/or 3D printing kit include a detailing agent. The detailing agent may include a surfactant, a co-solvent, and a balance of water. In some examples, the detailing agent consists of these components, and no other components. In some other examples, the detailing agent may further include a colorant. In still some other examples, detailing agent consists of a colorant, a surfactant, a co-solvent, and a balance of water, with no other components. In yet some other examples, the detailing agent may further include additional components, such as anti-kogation agent(s), antimicrobial agent(s), and/or chelating agent(s) (each of which is described above in reference to the dielectric agent).

The surfactant(s) that may be used in the detailing agent include any one or combination of surfactants listed herein in reference to the dielectric agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the dielectric agent. The total amount of co-solvent(s) in the detailing agent may range from about 1.00 wt % to about 65.00 wt % with respect to the total weight of the detailing agent.

In some examples, the detailing agent does not include a colorant. In these examples, the detailing agent may be colorless. As used herein, “colorless,” means that the detailing agent is achromatic and does not include a colorant.

When the detailing agent includes the colorant, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the active (energy absorbing) material in the fusing agent, which absorbs wavelengths within the near-infrared spectrum. As such, the colorant in the detailing agent will not substantially absorb the fusing radiation, and thus will not initiate melting and fusing (coalescence) of the build material composition in contact therewith when the build material layer is exposed to the energy.

It may be desirable to add color to the detailing agent when the detailing agent is applied to the edge of a colored part. Color in the detailing agent may be desirable when used at a part edge because some of the colorant may become embedded in the build material 24 that fuses/coalesces at the edge. As such, in some examples, the dye in the detailing agent may be selected so that its color matches the color of the energy in the fusing agent. As examples, the dye may be any azo dye having sodium or potassium counter ion(s) or any diazo (i.e., double azo) dye having sodium or potassium counter ion(s), where the color of azo or dye azo dye matches the color of the fusing agent.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl) azo-1-naphthyl]hydrazono]naphthalene-1,7-disulfonate with a chemical structure of:

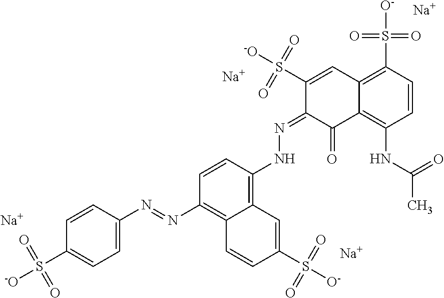

(commercially available as Food Black 1); tetrasodium 6-amino-4-hydroxy-3-[[7-sulfonato-4-[(4-sulfonatophenyl) azo]-1-naphthyl]azo]naphthalene-2,7-disulfonate with a chemical structure of:

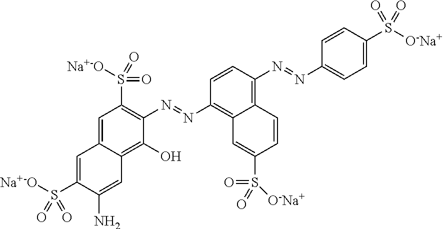

(commercially available as Food Black 2); tetrasodium (6E)-4-amino-5-oxo-3-[[4-(2-sulfonatooxyethylsulfonyl)phenyl]diazenyl]-6-[4-(2-sulfonatooxyethylsulfonyl)phenyl]hydrazinylidene]naphthalene-2,7-disulfonate with a chemical structure of:

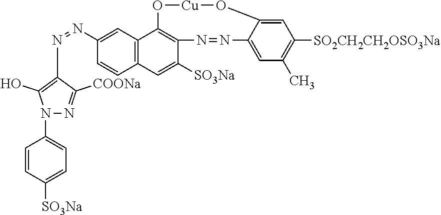

(commercially available as Reactive Black 31); tetrasodium (6E)-4-amino-5-oxo-3-[[4-(2-sulfonatooxyethylsulfonyl)phenyl]diazenyl]-6-[4-(2-sulfonatooxyethylsulfonyl)phenyl]hydrazinylidene]naphthalene-2,7-disulfonate with a chemical structure of:

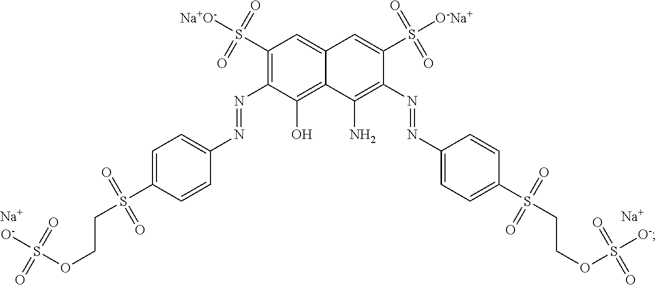

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D part.

Some examples of the other dye include a salt, such as a sodium salt, an ammonium salt, or a potassium salt. Some specific examples include ethyl-[4-[4-[ethyl-[(3-sulfophenyl)methyl]amino]phenyl]-(2-sulfophenyl)ethylidene]-1-cyclohexa-2,5-dienylidene]-[(3-sulfophenyl)methyl] azanium with a chemical structure of:

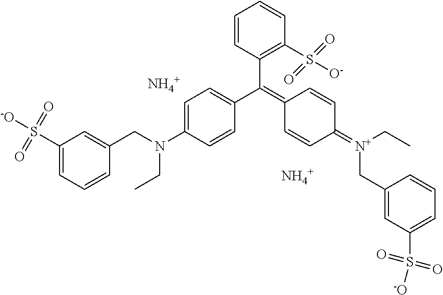

(commercially available as Acid Blue 9, where the counter ion may alternatively be sodium counter ions or potassium counter ions); sodium 4-[(E)-{4-[benzyl(ethyl)amino]phenyl} {(4E)-4-[benzyl(ethyl) iminio]cyclohexa-2,5-dien-1-ylidene}methyl]benzene-1,3-disulfonate with a chemical structure of:

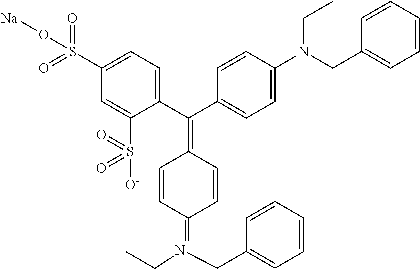

(commercially available as Acid Blue 7); and a phthalocyanine with a chemical structure of:

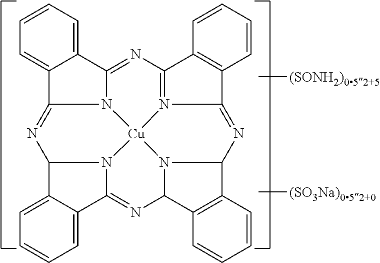

(commercially available as Direct Blue 199); and combinations thereof.

In an example of the detailing agent, the dye may be present in an amount ranging from about 1.00 wt % active to about 3.00 wt % active based on the total weight of the detailing agent. In another example of the detailing agent including a combination of dyes, one dye (e.g., the black dye) is present in an amount ranging from about 1.50 wt % active to about 1.75 wt % active based on the total weight of the detailing agent, and the other dye (e.g., the cyan dye) is present in an amount ranging from about 0.25 wt % active to about 0.50 wt % active based on the total weight of the detailing agent.

The balance of the detailing agent is water. As such, the amount of water may vary depending upon the amounts of the other components that are included.

### Printing Methods and Methods of Use

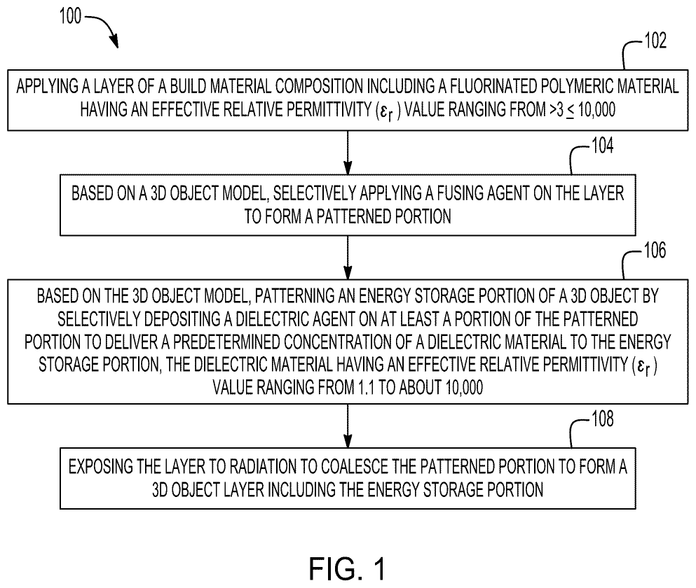

Different examples of the 3D printing method are shown and described in reference to FIG. 1 through FIG. 3.

Prior to execution of any examples of the method, it is to be understood that a controller may access data stored in a data store pertaining to a 3D part/object that is to be printed. For example, the controller may determine the number of layers of the build material composition that are to be formed, the locations at which any of the agents is/are to be deposited on each of the respective layers, etc.

The method 100 shown in FIG. 1 includes applying a layer of a build material composition including a fluorinated polymeric material having an effective relative permittivity (εᵣ) value ranging from >3 to ≤10,000 (reference numeral 102); based on a 3D object model, selectively applying a fusing agent on the layer to form a patterned portion (reference numeral 104); based on the 3D object model, patterning an energy storage portion of a 3D object by selectively depositing a dielectric agent on at least a portion of the patterned portion to deliver a predetermined concentration of a dielectric material to the energy storage portion, the dielectric material having an effective relative permittivity (εᵣ) value ranging from 1.1 to about 10,000 (reference numeral 106); and exposing the layer to radiation to coalesce the patterned portion to form a 3D object layer including the energy storage portion (reference numeral 108).

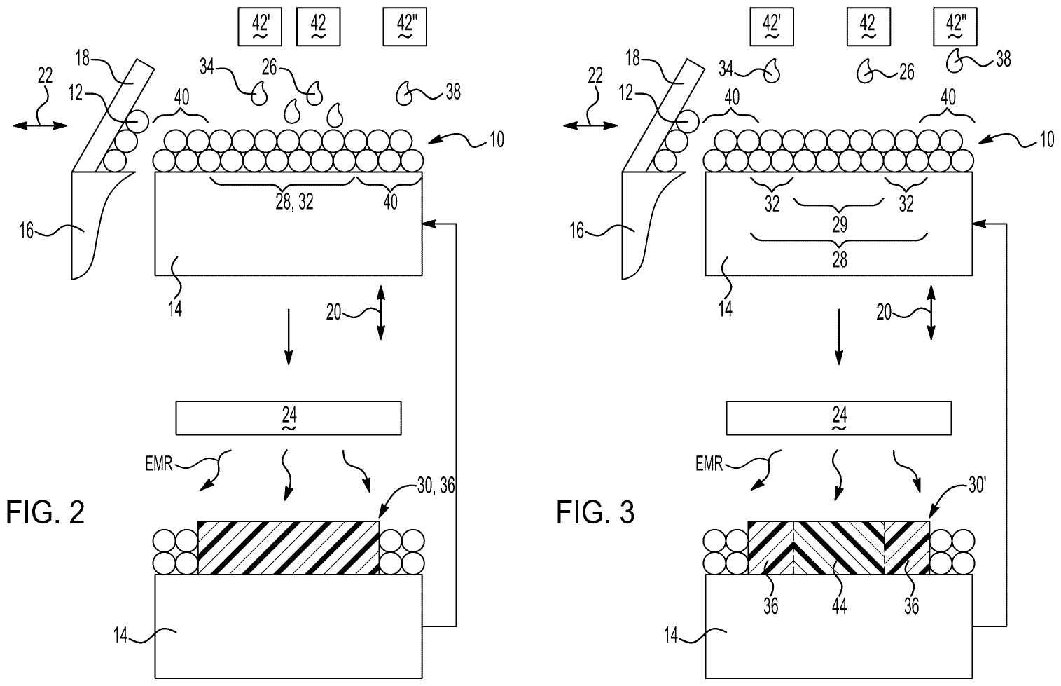

The method 100 is shown schematically in FIG. 2. In FIG. 2, a layer 10 of the build material composition 12 is applied on a build area platform 14. A printing system may be used to apply the build material composition 12. The printing system may include the build area platform 14, a build material supply 16 containing the build material composition 12, and a build material distributor 18.

The build area platform 14 receives the build material composition 12 from the build material supply 16. The build area platform 14 may be moved in the directions as denoted by the arrow 20, e.g., along the z-axis, so that the build material composition 12 may be delivered to the build area platform 14 or to a previously formed layer. In an example, when the build material composition 12 is to be delivered, the build area platform 14 may be programmed to advance (e.g., downward) enough so that the build material distributor 18 can push the build material composition 12 onto the build area platform 14 to form a substantially uniform layer 10 of the build material composition 12 thereon. The build area platform 14 may also be returned to its original position, for example, when a new part is to be built.

The build material supply 16 may be a container, bed, or other surface that is to position the build material composition 12 between the build material distributor 18 and the build area platform 14. The build material supply 16 may include heaters so that the build material composition 12 is heated to a supply temperature ranging from about 25° C. to about 150° C. In these examples, the supply temperature may depend, in part, on the build material composition 12 used and/or the 3D printer used. As such, the range provided is one example, and higher or lower temperatures may be used.

The build material distributor 18 may be moved in the directions as denoted by the arrow 22, e.g., along the y-axis, over the build material supply 16 and across the build area platform 14 to spread the layer 10 of the build material composition 12 over the build area platform 14. The build material distributor 18 may also be returned to a position adjacent to the build material supply 16 following the spreading of the build material composition 12. The build material distributor 18 may be a blade (e.g., a doctor blade), a roller, a combination of a roller and a blade, and/or any other device capable of spreading the build material composition 12 over the build area platform 14. For instance, the build material distributor 18 may be a counter-rotating roller. In some examples, the build material supply 16 or a portion of the build material supply 16 may translate along with the build material distributor 18 such that build material composition 12 is delivered continuously to the build area platform 14 rather than being supplied from a single location at the side of the printing system as depicted in FIG. 2.

The build material supply 16 may supply the build material composition 12 into a position so that it is ready to be spread onto the build area platform 14. The build material distributor 18 may spread the supplied build material composition 12 onto the build area platform 14. The controller (not shown) may process “control build material supply” data, and in response, control the build material supply 16 to appropriately position the particles of the build material composition 12, and may process “control spreader” data, and in response, control the build material distributor 18 to spread the build material composition 12 over the build area platform 14 to form the layer 10 of the build material composition 12 thereon. In FIG. 2, one build material layer 10 has been formed.

The layer 10 has a substantially uniform thickness across the build area platform 14. In an example, the build material layer 10 has a thickness ranging from about 50 μm to about 120 μm. In another example, the thickness of the build material layer 26 ranges from about 30 μm to about 300 μm. It is to be understood that thinner or thicker layers may also be used. For example, the thickness of the build material layer 10 may range from about 20 μm to about 500 μm. The layer thickness may be about 2× (i.e., 2 times) the average diameter of the build material composition particles at a minimum for finer part definition. In some examples, the layer thickness may be about 1.2× the average diameter of the build material composition particles.

After the build material composition 12 has been applied, and prior to further processing, the build material layer 10 may be exposed to pre-heating. In an example, the pre-heating temperature may be below the melting point of the fluorinated polymeric material of the build material composition 12. As examples, the pre-heating temperature may range from about 5° C. to about 50° C. below the melting point of the fluorinated polymeric material. In an example, the pre-heating temperature ranges from about 50° C. to about 150° C. In still another example, the pre-heating temperature ranges from about 75° C. to about 125° C. It is to be understood that the pre-heating temperature may depend, in part, on the fluorinated polymeric material used. As such, the ranges provided are some examples, and higher or lower temperatures may be used.

Pre-heating the layer 10 may be accomplished by using any suitable heat source that exposes all of the build material composition 12 in the layer 10 to the heat. Examples of the heat source include a thermal heat source (e.g., a heater (not shown) integrated into the build area platform 14 (which may include sidewalls)) or a radiation source 24.

After the layer 10 is formed, and in some instances is pre-heated, the fusing agent(s) 26 is selectively applied on at least some of the build material composition 12 in the layer 10 to form a patterned portion 28.

To form a layer 30 of a 3D object, at least a portion (e.g., patterned portion 28) of the layer 10 of the build material composition 12 is patterned with the fusing agent 26.

The volume of the fusing agent 26 that is applied per unit of the build material composition 12 in the patterned portion 28 may be sufficient to absorb and convert enough electromagnetic radiation so that the build material composition 12 in the patterned portion 28 will coalesce/fuse. The volume of the fusing agent 26 that is applied per unit of the build material composition 12 may depend, at least in part, on the energy absorber used, the energy absorber loading in the fusing agent 26, and the build material composition 12 used. If the energy absorber in the fusing agent 26 is electrically conducting, the volume of the fusing agent 26 that is applied may be less than 33 vol. % so that the dielectric property of the resulting 3D object layer 30 is not deleteriously affected.

To increase the dielectric property of at least a portion of the layer 30 of the 3D object, corresponding portion(s) 32 of the patterned portion 28 is/are also patterned with the dielectric agent 34. The dielectric agent 34 may be applied in accordance with 3D object model wherever it is desirable for the final 3D object layer 30 to exhibit a particular effective relative permittivity (εᵣ) value, which is suitable for energy storage. Utilizing a dielectric agent 34 that is separate from the fusing agent 26 enables 3D objects with tailored energy storage portions 36 to be formed. In the example shown in FIG. 2, the entire 3D object layer 30 is an energy storage portion 36.

The volume of the dielectric agent 34 that is applied per unit of the build material composition 12 in the portion 32 may depend upon the effective relative permittivity (εᵣ) value that is to be exhibited by the layer 30, the effective relative permittivity (εᵣ) value of the fluorinated polymeric material in the build material composition 12, the effective relative permittivity (εᵣ) value of the dielectric material in the dielectric agent 34, and the volume of the fusing agent 26 that is applied. In some instances, the volume of the dielectric agent 34 that is applied may also depend upon whether the energy absorber in the fusing agent 26 is electrically conductive.

In some examples, the dielectric constant for the coalesced composite material or the volume fraction of each of the fusing agent 26 and the dielectric agent 34 may be determined using the following equation:

$${( {ε}_{eff} )}^{1 / 3} = {( {f}_{1} {ε}_{1} )}^{1 / 3} + {( {f}_{2} {ε}_{2} )}^{1 / 3} \qquad ( eq . 1 )$$

where ε_{eff} is the dielectric constant for the coalesced composite material, ε₁ is the dielectric constant for the dielectric material in the dielectric agent 34, ε₂ is the dielectric constant for the fluorinated polymeric material in the build material composition 12, f₁ is the volume fraction of the dielectric material, and f₂ is the volume fraction of the fluorinated polymeric material. Equation 1 may be used to form an energy storage portion 36 having the desired dielectric constant ε_{eff}. For example, for known volume fractions, the desired dielectric constant ε_{eff} may be calculated. Alternatively, to achieve a predetermined desired dielectric constant ε_{eff}, the volume fractions may be calculated. In some examples, the energy storage portion 36 exhibits an effective relative permittivity (εᵣ) value (dielectric constant ε_{eff}) ranging from about 10 to about 35 at a frequency ranging from about 102 Hz to about 106 Hz.

In some examples, the volume fraction of the dielectric material in the energy storage portion 36 ranges from about 1 vol % to about 80 vol %. In other examples, the volume fraction of the dielectric material in the energy storage portion 36 ranges from about 1 vol % to about 35 vol %. In still other examples, the volume fraction of the dielectric material in the energy storage portion 36 is 33 vol % or less. Because the dielectric material is not electrically conducting, the volume fraction may exceed the percolation threshold (i.e., the volume fraction where the nanoparticles begin to contact each other) without creating electrical shorting paths. The limiting volume in the examples disclosed herein may be a point at which the dielectric material begins to deleteriously influence the mechanical properties of the 3D printed object.

In the example shown in FIG. 2, the entire 3D object layer 30 has its dielectric property altered with the dielectric agent 34. In this example, a single patterning agent may be used. The single patterning agent is an example of the dielectric agent 34 that also includes the energy absorber. In this example, the fusing agent 26 and the dielectric agent 34 are effectively combined into the single patterning agent, and the entire 3D object layer 30 includes the energy storage portion 36.

In the example shown in FIG. 2, the detailing agent 38 is also selectively applied to the portion(s) 40 of the layer 10. The portion(s) 40 are not patterned with the fusing agent 26 and thus are not to become part of the final 3D object layer 30. Thermal energy generated during radiation exposure may propagate into the surrounding portion(s) 40 that do not have the fusing agent 26 applied thereto. The propagation of thermal energy may be inhibited, and thus the coalescence of the non-patterned build material portion(s) 40 may be prevented, when the detailing agent 38 is applied to these portion(s) 40.

After the agents 26, 34, and 38 are selectively applied in the specific portion(s) 28, 32, and 40 of the layer 10, the entire layer 10 of the build material composition 12 is exposed to energy, e.g., in the form of electromagnetic radiation (shown as EMR in FIG. 1).

The electromagnetic radiation is emitted from the radiation source 24. The length of time the electromagnetic radiation is applied for, or energy exposure time, may be dependent, for example, on one or more of: characteristics of the radiation source 24; characteristics of the build material composition 12; and/or characteristics of the fusing agent 26.

It is to be understood that the electromagnetic radiation exposure may be accomplished in a single radiation event or in multiple radiation events. In an example, the exposing of the build material composition 12 is accomplished in multiple radiation events. In a specific example, the number of radiation events ranges from 3 to 8. In still another specific example, the exposure of the build material composition 12 to electromagnetic radiation may be accomplished in 3 radiation events. It may be desirable to expose the build material composition 12 to electromagnetic radiation in multiple radiation events to counteract a cooling effect that may be brought on by the amount of the agents 26, 34, 38 that is applied to the build material layer 10. Additionally, it may be desirable to expose the build material composition 12 to electromagnetic radiation in multiple radiation events to sufficiently elevate the temperature of the build material composition 12 in the portion(s) 28, 32, without over heating the build material composition 12 in the non-patterned portion(s) 40.

The fusing agent 26 enhances the absorption of the radiation, converts the absorbed radiation to thermal energy, and promotes the transfer of the thermal heat to the build material composition 12 in contact therewith. In an example, the fusing agent 26 sufficiently elevates the temperature of the build material composition 12 in the portion 28 to a temperature above the melting point of the fluorinated polymeric material, allowing coalescing/fusing (e.g., thermal merging, melting, binding, etc.) of the build material composition 12 to take place. As such, the application of the electromagnetic radiation forms the 3D object layer 30, which, in some examples, includes the energy storage portion 36. Within the energy storage portion 36, the dielectric material becomes embedded in the coalesced fluorinated polymeric material and causes that/those region(s) 36 to exhibit the desired dielectric property.

In some examples, the electromagnetic radiation has a wavelength ranging from 800 nm to 4000 nm, or from 800 nm to 1400 nm, or from 800 nm to 1200 nm. Radiation having wavelengths within the provided ranges may be absorbed (e.g., 80% or more of the applied radiation is absorbed) by the fusing agent 26 and may heat the build material composition 12 in contact therewith, and may not be substantially absorbed (e.g., 25% or less of the applied radiation is absorbed) by the non-patterned build material composition 12 in portion(s) 40.

In the example shown in FIG. 2, the entire 3D object layer 30 is an energy storage portion 36 exhibiting the desired effective relative permittivity value (ε_{eff}).

After the 3D object layer 30 is formed, additional layer(s) may be formed thereon to create an example of the 3D object. To form the next layer, additional build material composition 12 may be applied on the layer 30. The fusing agent 26 is then selectively applied on at least a portion of the additional build material composition 12, according to the 3D object model. The dielectric agent 34 may also be applied, for example, if energy storage capability is desired in the next layer. The detailing agent 38 may be applied in any area of the additional build material composition 12 where coalescence is not desirable. After the agent(s) 26, 34, 38 is/are applied, the entire layer of the additional build material composition 12 is exposed to electromagnetic radiation in the manner described herein. The application of additional build material composition 12, the selective application of the agent(s) 26, 34, 38, and the electromagnetic radiation exposure may be repeated a predetermined number of cycles to form the final 3D object 30 in accordance with the 3D object model.

Referring now to FIG. 3, another example of the method 100 is schematically depicted. In this example, the portion 32 is a fraction of the patterned portion 28 so that another portion 29 of the patterned portion 28 includes the fusing agent 26 and not the dielectric agent 34; and during the exposing, the other portion 29 coalesces to form a remaining portion 44 of the 3D object layer that does not include the energy storage portion 36.

In FIG. 3, one layer 10 of the build material composition 12 is applied on the build area platform 14 as described in reference to FIG. 2. After the build material composition 12 has been applied, and prior to further processing, the build material layer 10 may be exposed to pre-heating as described in reference to FIG. 2.

In this example of the method 100, the fusing agent 26 is selectively applied on at least some of the build material composition 12 in the layer 10 to form the patterned portion 28, and the dielectric agent 34 is selectively applied some, but not all, of the patterned portion 28. As such, the entire patterned portion 28 includes the fusing agent 26, but portion 29 does not include the dielectric agent 34 and portion 32 does include in the dielectric agent.

In the example shown in FIG. 3, the detailing agent 38 is also selectively applied to the portion(s) 40 of the layer 10. The portion(s) 40 are not patterned with the fusing agent 26 and thus are not to become part of the final 3D object layer 30′.

After the agents 26, 34, and 38 are selectively applied in the specific portion(s) 28 (including 29 and 32) and 40 of the layer 10, the entire layer 10 of the build material composition 12 is exposed to electromagnetic radiation (shown as EMR in FIG. 3). Radiation exposure may be accomplished as described in reference to FIG. 2.

In this example, the fusing agent 26 enhances the absorption of the radiation, converts the absorbed radiation to thermal energy, and promotes the transfer of the thermal heat to the build material composition 12 in contact therewith. In an example, the fusing agent 26 sufficiently elevate the temperature of the build material composition 12 in the portion 28 (including portions 29 and 32) to a temperature above the melting point or within the melting range of the polymeric material, allowing coalescing/fusing (e.g., thermal merging, melting, binding, etc.) of the build material composition 12 to take place. The application of the electromagnetic radiation forms the 3D object layer 30′, which, in this example, includes the energy storage portions 36 at opposed ends of the remaining portion 44 (which is not an energy storage portion 36).

FIG. 3 illustrates one example of how the dielectric agent 34 may be selectively applied to pattern different energy storage portions 36 in a single build material layer 10. In this particular example, the edges of the layer 30′ are rendered capable of storing energy.

In any of the examples of the method 100 disclosed herein, any of the agents (fusing agent 26, dielectric agent 34, detailing agent 38) may be dispensed from an applicator 42, 42′, 42″ (shown in FIG. 2 and FIG. 3). The applicator(s) 42, 42′, 42″ may each be a thermal inkjet printhead, a piezoelectric printhead, a continuous inkjet printhead, etc., and the selective application of the fusing agent 26, dielectric agent 34, and/or detailing agent 38 may be accomplished by thermal inkjet printing, piezo electric inkjet printing, continuous inkjet printing, etc. The controller may process data, and in response, control the applicator(s) 42, 42′, 42″ to deposit the fusing agent 26, dielectric agent 34, and/or detailing agent 38 onto predetermined portion(s) of the build material composition 12. It is to be understood that the applicators 42, 42′, 42″ may be separate applicators or a single applicator with several individual cartridges for dispensing the respective agents.

It is to be understood that the selective application of any of the fusing agent 26, dielectric agent 34 and/or detailing agent 38 may be accomplished in a single printing pass or in multiple printing passes. In some examples, the agent(s) is/are selectively applied in a single printing pass. In some other examples, the agent(s) is/are selectively applied in multiple printing passes. If higher concentrations of the dielectric material are to be included in the final composite, than the number of printing pass may be higher depending upon the concentration of the dielectric material in the dielectric agent. In some examples, the number of printing passes may be up to 100. In one of these examples, the number of printing passes may range from about 2 to about 50, or from 5 to 75, or from 10 to 40. In still other examples, 2 or 4 or 50, or 80 or 95 printing passes are used. It may be desirable to apply the fusing agent 26, dielectric agent 34 and/or detailing agent in multiple printing passes to increase the amount, e.g., of the energy absorber, dielectric material, etc. that is applied to the build material composition 12, to avoid liquid splashing, to avoid displacement of the build material composition 12, etc.

In any of the examples of the method 100 disclosed herein, differently shaped objects may be printed in different orientations within the printing system. As such, while the object may be printed from the bottom of the object to the top of the object, it may alternatively be printed starting with the top of the object to the bottom of the object, or from a side of the object to another side of the object, or at any other orientation that is suitable or desired for the particular geometry of the part being formed.

3D printed objects with energy storage portions 36 may be used in a variety of applications. Some example applications include wireless nodes, energy harvesting systems, sensors, and other electronic systems that operate autonomously. The voxel level control enabled by the examples disclosed herein allow any type of energy storage device to be printed, including, for example, those of small physical size (e.g., an autonomous wireless sensor node).

To further illustrate the present disclosure, an example is given herein. It is to be understood that this example is provided for illustrative purposes and is not to be construed as limiting the scope of the present disclosure.

### EXAMPLE

Nanocomposite films were prepared with poly(vinylidene fluoride) and different volume fractions (ranging from 10 vol % to 80 vol %) of barium titanate nanoparticles.

These films were 3D printed by spreading a layer of poly(vinylidene fluoride) on a build area platform, patterning the layer with a fusing agent and a dielectric agent, and then exposing the layer to electromagnetic radiation. Additional layers were printed in a similar manner to form the films.

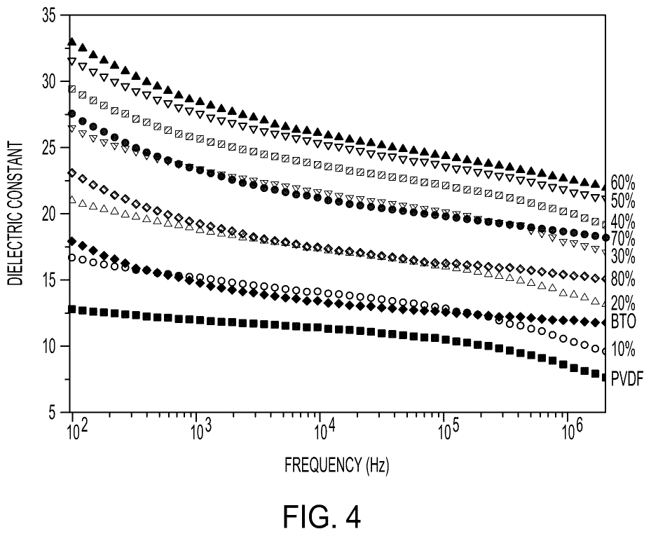

The dielectric constant of each film was measured at different frequencies (ranging from 102 Hz to 106 Hz). The results are shown in FIG. 4. As controls, the dielectric constant of PVDF and of the barium titanate nanoparticles was also measured. As depicted in FIG. 4, the dielectric constant of each of the composite films was higher than the PVDF film without any added barium titanate nanoparticles. At the higher volume fractions (e.g., above about 33 vol %), the nanoparticles are close to the percolation threshold, and thus have a higher probability of forming connected networks that can deleteriously affect the dielectric constant.

It is to be understood that the ranges provided herein include the stated range and any value or sub-range within the stated range, as if such values or sub-ranges were explicitly recited. For example, from about 1 wt % to about 20 wt % should be interpreted to include not only the explicitly recited limits of from about 1 wt % to about 20 wt %, but also to include individual values, such as about 1.5 wt %, about 14 wt %, about 7.75 wt %, about 19 wt %, etc., and sub-ranges, such as from about 1.25 wt % to about 10 wt %, from about 3.2 wt % to about 15.2 wt %, from about 3 wt % to about 8 wt %, etc.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. As an example, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. (canceled)

2. (canceled)

3. The method as defined in claim 9 wherein the dielectric material is a metal oxide nanoparticle.

4.-6. (canceled)

7. The method as defined in claim 9 wherein the dielectric material is selected from the group consisting of barium titanate nanoparticles, lead zirconium titanate nanoparticles, silicon dioxide nanoparticles, silicon nitride nanoparticles, aluminum oxide nanoparticles, zirconium oxide nanoparticles, titanium oxide nanoparticles, tantalum pentoxide nanoparticles, barium strontium titanate nanoparticles, strontium titanate oxide nanoparticles, and combinations thereof.

8. The method as defined in claim 9 wherein the fusing agent includes an energy absorber and a liquid vehicle, and wherein the energy absorber is a plasmonic resonance absorber having absorption at wavelengths ranging from 800 nm to 4000 nm and having transparency at wavelengths ranging from 400 nm to 780 nm.

9. A method for three-dimensional printing, comprising:
applying a layer of a build material composition including a fluorinated polymeric material having an effective relative permittivity (εᵣ) value ranging from >3 to ≤10,000;
based on a 3D object model, selectively applying a fusing agent on the layer to form a patterned portion;
based on the 3D object model, patterning an energy storage portion of a 3D object by selectively depositing a dielectric agent on at least a portion of the patterned portion to deliver a predetermined concentration of a dielectric material to the energy storage portion, the dielectric material having an effective relative permittivity (εᵣ) value ranging from 1.1 to about 10,000; and
exposing the layer to energy to coalesce the patterned portion to form a 3D object layer including the energy storage portion.

10. The method as defined in claim 9 wherein the fluorinated polymeric material is selected from the group consisting of polyvinylidene fluoride, a poly(vinylidene fluoride-trifluoroethylene) copolymer, a poly(vinylidene fluoride-tetrafluoroethylene) copolymer, a poly(vinylidene fluoride-hexafluoroethylene) copolymer, a poly(vinylidene fluoride-hexafluoropropylene) copolymer, a poly(vinylidene fluoride-chlorofluoroethylene) copolymer, a poly(vinylidene fluoride-chlorotrifluoroethylene) copolymer, a poly(vinylidene fluoride-trifluoroethylene-chlorotrifluoroethylene) terpolymer, a poly(vinylidene fluoride-trifluoroethylene-chlorofluoroethylene) terpolymer, and blends thereof.

11. The method as defined in claim 9 wherein the energy storage portion exhibits an effective relative permittivity (εᵣ) value ranging from about 10 to about 35 at a frequency ranging from about 102 Hz to about 106 Hz.

12. The method as defined in claim 9 wherein:
the at least the portion is a fraction of the patterned portion so that an other portion of the patterned portion includes the fusing agent and not the dielectric agent; and
during the exposing, the other portion coalesces to form a remaining portion of the 3D object layer that does not include the energy storage portion.

13. The method as defined in claim 9 wherein the predetermined concentration of the dielectric material ranges from about 1 vol % to about 80 vol % of the energy storage portion.

14. The method as defined in claim 9 wherein the fusing agent and the dielectric are combined into a single patterning agent and wherein the entire 3D object layer includes the energy storage portion.

15. The method as defined in claim 9, further comprising repeating the applying of the build material composition, the selectively applying of the fusing agent, the selectively applying of the dielectric agent, and the exposing to form a predetermined number of 3D object layers and a 3D printed object, wherein at least some of the predetermined number of 3D object layers includes the energy storage portion.

16. The method as defined in claim 9 wherein the dielectric agent includes:
the dielectric material; and
a liquid vehicle including water and one or more additives selected from the group consisting of a co-solvent, a viscosity modifier, a surfactant, an anti-kogation agent, an antimicrobial agent, and a chelating agent.

17. The method as defined in claim 9 wherein the fusing agent includes an energy absorber and a liquid vehicle, and wherein the energy absorber is an inorganic pigment.

18. The method as defined in claim 9 wherein the predetermined concentration of the dielectric material ranges from about 1 vol % to about 35 vol % of the energy storage portion.

19. The method as defined in claim 9 wherein the dielectric material is present in the dielectric agent in an amount ranging from about 2 wt % to about 50 wt % based on a total weight of the dielectric agent.

20. The method as defined in claim 9 wherein the dielectric material is present in the dielectric agent in an amount ranging from about 22 wt % to about 50 wt % based on a total weight of the dielectric agent.
